(19) United States
(12) Patent Application Publication
(10) Pub. No.: US 2014/0379731 A1
(43) Pub. Date: Dec. 25, 2014

(54) VIDEO SEARCH

(71) Applicants: Amol Sunil Dixit, Kothrud (IN); Krishnan Ramanathan, Bangalore (IN); Yogesh Sankarasubramaniam, Bangalore (IN); Vidhya Govindaraju, Bangalore (IN)

(72) Inventors: Amol Sunil Dixit, Kothrud (IN); Krishnan Ramanathan, Bangalore (IN); Yogesh Sankarasubramaniam, Bangalore (IN); Vidhya Govindaraju, Bangalore (IN)

(21) Appl. No.: 14/373,493

(22) PCT Filed: Feb. 27, 2012
(86) PCT No.: PCT/IN2012/000133

§ 371 Date: Jul. 21, 2014

(51) Int. Cl. G06F 17/30

(52) U.S. Cl. CPC G06F 17/30823
USPC 707/748

(57) ABSTRACT

Provided is a computer-implemented method of performing a video search. A search query is analyzed to identify a first set of query terms. The first set of query terms are used to query a knowledge repository, wherein the knowledge repository is a collection of electronic documents. An electronic document corresponding to the first set of query terms is identified and parsed to obtain a second set of query terms. Query terms present in the second set are ranked and top N ranked query terms are provided to a video search engine.

### BACKGROUND

Internet has emerged as the preferred medium for people looking for information. From finding word meanings to searching for a detailed essay on a scientific breakthrough, the World Wide Web (WWW) provides an immediate response to a user's information needs. According to an estimate, on an average three billion plus searches are performed each day on the internet. A typical internet search requires a user to provide a keyword or a set of keywords to a search engine. In response, the search engine displays the search results, which may be in the form of text documents, web pages, URLs (Uniform Resource Locator), etc.

### BRIEF DESCRIPTION OF THE DRAWINGS

For a better understanding of the solution, embodiments will now be described, purely by way of example, with reference to the accompanying drawings, in which:

FIG. 1 shows a flow chart of a method of performing a video search, according to an embodiment.

FIG. 2 illustrates a system for performing a video search, according to an embodiment.

### DETAILED DESCRIPTION OF THE INVENTION

As indicated earlier, millions of people perform billions of searches each day to find information on the internet. In most cases, the search results are in the form of text documents or web site links (URLs). However, video search (or search for videos uploaded to a network) is also not behind. With thousands of people uploading their videos every day, video search has become a popular method amongst people looking for a search experience which extends beyond written words. In fact, in some instances, a video is better than a text response. For example, a user looking for a method of wearing a tie would be much better served by a video describing the “tie wearing” process rather than a text document. To provide another example, a user looking to assemble a sofa or a game set would appreciate a video describing the process more than a tedious text manual.

Realizing the increasing user preference to search for videos rather than text documents (or web pages), whether it is for information or recreation, a number of mechanisms have been proposed to perform a video search. However, it has been identified that in most cases, the video search results do not provide results that match the user intent. The search results are either too generic or plainly vague, thereby leaving a user with an unsatisfied experience. This is mainly because the results are provided using simple keyword matching without a deeper understanding of the user intent or query. Needless to say, this is not an ideal situation from a user's perspective.

Embodiments of the present solution provide a method and system for performing a video search on a computer network (such as intranet or the internet) using a search engine (for example, a video search engine).

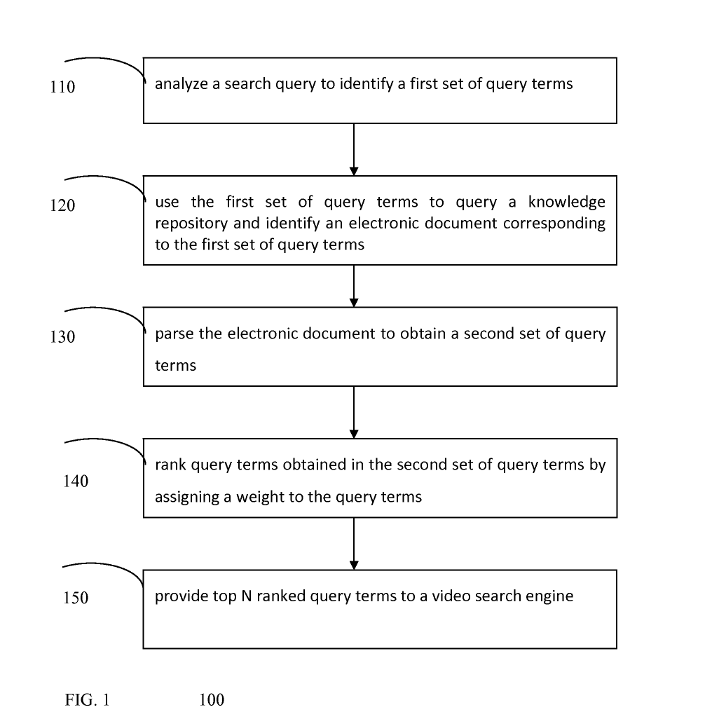

FIG. 1 shows a flow chart of a method of performing a video search, according to an embodiment.

The method may be implemented in a computing system, such as, but not limited to, a desktop computer, a notebook computer, a server computer, a personal digital assistant (PDA), a mobile device, a touch pad, a television (TV) set, a docking device, and the like. The computing system may be connected to a computer network, such as, an intranet or the internet (World Wide Web), through wired (for example, co-axial cable) or wireless (for example, Wi-Fi) means.

At block 110, a computing system receives a video search query from a user. In an example, the computing system has an input interface to receive the video search query from the user. The input interface includes a software interface (such as a graphical user interface (GUI)) and/or a hardware interface for providing a search input (such as a keyboard).

In an example, the video search query is a text based search query comprising a keyword or a string of keywords, which a user identifies. For example, if a user intends to search for “How to assemble a computer”, he or she may provide the complete query string i.e. “How to assemble a computer”, or a string of keywords “assembling a computer”, and the like. The choice of query keywords lies with the user.

In another example, the video search query is a voice (speech) based search query comprising a keyword or a string of keywords. For example, if a user intends to search for “How to assemble a computer”, he or she may provide the query string by providing a speech command to the computing system. In such instance, the computing device is provided with a speech capture device and speech recognition means. The computing device may also have a speech-to-text conversion computer program (a set of machine readable instructions which can be executed by a processor of the computing system).

Upon receipt of the video search query, the computing system analyses the video search query to identify a first set of query terms. This part of the method may be termed as “question processing”. The “question processing” part may be implemented by a question processing module which, in one example, may reside in the memory of the computing system. During question processing, the method analyses the video search query from a user and tries to find the information need of the user. The idea is to identify those keywords in the search query which replicate the search intent of the user. This is carried out by performing a part-of-speech tagging (on the search query) to identify two types of words in the search query.

The first type of words is called “noun phrases”. It includes all nouns and proper nouns in the search query. The second type of words is called “Focus words”. It includes all nouns, proper nouns, non-trivial verbs, adjectives and numbers.

The words identified as “noun phrases” and/or “focus words” are recognized as a first set of query terms. To provide an example, in a video search query “How to repair a computer”, terms “how”, “repair” and “computer” would be identified as a first set of query terms. To provide another example, in a video search query “How to wear a tie”, terms “how”, “wear” and “tie” would be acknowledged as a first set of query terms.

At block 120, after a first set of query terms have been identified, the computing system, in an example, uses the “noun phrases” from the first set of query terms to query a knowledge repository. In another example, the first set of query terms are used to query a knowledge repository.

A knowledge repository may be defined as a computerized system (or database) that systematically captures, organizes and categorizes knowledge in the form of a collection of electronic documents. The repository can be searched and data is retrievable. To provide an illustration, an online encyclopedia, such as Wikipedia or Britannica Online, is a knowledge repository.

The practice of using the first set of query terms to query a knowledge repository may be termed as “question understanding” part of the method. The “question understanding” part may be implemented by a question understanding module which, in one example, may reside in the memory of the computing system.

The query to a knowledge repository results in identifying electronic document(s) that corresponds to the first set of query terms. In an example, the “noun phrases” from the first set of query terms are used to query the Wikipedia repository to identify an electronic document(s) corresponding to the “noun phrases”. The process involves using the Wikipedia search API (Application Programming Interface) to query the Wikipedia repository. For example a query “How did the Universe originate” might give the Wikipedia page on Big Bang (http://en.wikipedia.org/wiki/Big_Bang)

An electronic document(s) corresponding to the first set of query terms is identified using Wikipedia categories. Wikipedia uses a category system, which provides links to all Wikipedia articles in the form of a hierarchy of categories. The categories allow articles to be placed in one or more groups, and allow those groups to be further categorized. Each article in Wikipedia belongs to at least one category. There are two kinds of categories in Wikipedia. Topic categories are named after a topic and usually share a name with the Wikipedia article on that topic. For example, category “Cricket” would contain all articles related to cricket. Set categories are created for a class of object. For example, category “Wines of France” contains articles whose subjects are wines of France.

In an example, an electronic document(s) corresponding to a first set of query terms may include a web page(s). However, in other instances, an electronic document may include a document containing text, audio and/or video.

At block 130, once an electronic document(s) corresponding to a first set of query terms has been indentified, it is passed to a regular expression based parser to extract the following information.

(a) Section headings: These include list of all section headings in the identified electronic document.

(b) Sub-section headings: These include list of all sub-section headings in the identified electronic document.

(c) Hyperlinks: These include all hyperlinks in the identified electronic document.

(d) Important noun phrases: These include all those noun phrases in the electronic document, which are not present in the section headings, sub-section headings and hyperlinks of the identified electronic document.

In an example, the extracted information (Section headings, Sub-section headings, hyperlinks and important noun phrases) is combined to form a second set of query terms. In another example, only some sections (or terms) of the extracted information is merged to obtain a second set of query terms. In one instance, duplicate terms are also removed to form a neat second set of query terms. It is to be noted that the phrase “query term” as used herein, in this document, may include one word or a set of words.

At block 140, the query terms in the second set are ranked. This part of the method may be termed as “question term ranking”. The “question term ranking” part may be implemented by a question term ranking module which, in one example, may reside in the memory of the computing system. During question term ranking, a weighting mechanism is used to assign weights to the query terms. Weighting may be carried out in different ways. Some of these means are described below. In one example, the final weight given to a query term is calculated by adding the individual weights assigned through different weighing methods.

The weighting may be done as follows. (1) Section/Sub-section headings: More weight is given to a query term present in a sub-section heading than to a term in a section heading. This is based on the premise that comparatively sub-section headings represent actual topic than section headings. (2) Word overlap: The extent of overlap between: (a) a query term and focus words and (b) query term and page title (for example, Wikipedia page title) is computed. A higher overlap indicates a more relevant query, and therefore a higher weight. (3) Hyperlinks: the hyperlinks in the electronic document are individually given a weight (as they represent, in case of Wikipedia repository, Wiki concepts). If a query term is present in a hyperlink, it is considered relatively more important and given a higher weight. (4) Important sections ranker: All section and sub-section headings with even a single non-zero word overlap with noun phrases are considered as important sections or sub-sections. Query terms which are present in a text associated with an important section or sub-section are given higher weight since they are more relevant. In other words, the method recognizes those section and sub-section headings of the electronic document which share at least one common term with the second set of query terms, and upon recognition assigning relatively more weight to those query terms which are present in a text associated with aforesaid section and sub-section headings of the electronic document.

Either or all of the above methods may be used to assign weights to the query terms. A final weight (to a query term) may be given by adding the individual weights assigned through different weighing methods. Assigning a final weight to the query terms (of the second set) results in a ranked list of query terms.

At block 150, top N (where N=1, 2, 3, 4 . . . ) ranked query terms are provided as an input to a video search engine. Selecting a value for N may be system determined or user defined.

In an example, the video search engine may be accessed via a web browser such as Windows Internet Explorer, Mozilla Firefox, Google Chrome, Opera, etc. A non-limiting example of video search includes YouTube.

The video search engine displays the results of top N ranked query terms to the user on a display coupled to the computing system.

In an example, prior to a display of video query search results, the search results are sorted on the basis of video coverage, diversity and relevance.

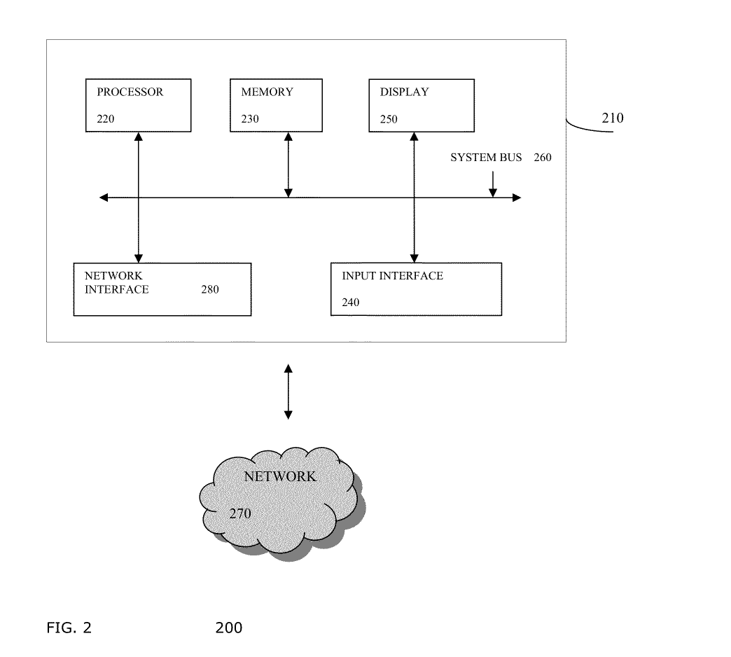

FIG. 2 illustrates a system for performing a video search, according to an embodiment.

The system 200 includes a computing system 210 connected to a computer network 270. The computing system 210 may be, but not limited to, a desktop computer, a notebook computer, a server computer, a personal digital assistant (PDA), a mobile device, a touch pad, a television (TV) set, a docking device, and the like.

Computing system 210 may include a processor 220, for executing machine readable instructions, a memory (storage medium) 230, for storing machine readable instructions (such as, a web browser module), an input interface 240 and a display 250. These components may be coupled together through a system bus 260.

Processor 220 is arranged to execute machine readable instructions. The machine readable instructions may be in the form of a web browser module 240. In an example, processor 220 executes machine readable instructions to: identify a first set of query terms from the video search query; use the first set of query terms to query a knowledge repository, wherein the knowledge repository is a collection of electronic documents; identify an electronic document corresponding to the first set of query terms; parse the electronic document to obtain a second set of query terms; rank query terms obtained in the second set of query terms, by assigning a weight to the query terms; and provide top N ranked query terms to a video search engine.

The memory 230 may include computer system memory such as, but not limited to, SDRAM (Synchronous DRAM), DDR (Double Data Rate SDRAM), Rambus DRAM (RDRAM), Rambus RAM, etc. or storage memory media, such as, a floppy disk, a hard disk, a CD-ROM, a DVD, a pen drive, etc. The memory 230 may include modules, such as, but not limited to, a web browser module 240.

The web browser module may be used to provide video search query terms to a video search engine. Some major web browser modules include Windows Internet Explorer, Mozilla Firefox, Google Chrome, and Opera.

The input interface 240 may be used to provide an initial seed set input to the computing system 210. The input interface 240 may include an input device, such as a keyboard or a mouse, and other user interaction mechanisms, such as a touch interface, a voice interface (such as microphone), a gesture interface, etc. The input interface also includes a software interface (such as a graphical user interface (GUI)). In an example, input interface 240 is used to receive a video search query from a user.

The display device 250 may be any device that enables a user to receive visual feedback. For example, the display may be a liquid crystal display (LCD), a light-emitting diode (LED) display, a plasma display panel, a television, a computer monitor, and the like.

The computer network 270 may be the internet or an intranet. The computing system 210 may be connected to a computer network 270, such as, an intranet or the internet (World Wide Web), through wired (for example, co-axial cable) or wireless (for example, Wi-Fi) means. A network interface controller 280 is used to connect the computing system 210 to the computer network 270.

It is clarified that the term “module”, as used in this document, may mean to include a software component, a hardware component or a combination thereof. A module may include, by way of example, components, such as software components, processes, functions, attributes, procedures, drivers, firmware, data, databases, and data structures. The module may reside on a volatile or non-volatile storage medium and configured to interact with a processor of a computer system.

It would be appreciated that the system components depicted in FIG. 2 are for the purpose of illustration only and the actual components may vary depending on the computing system and architecture deployed for implementation of the present solution. The various components described above may be hosted on a single computing system or multiple computer systems, including servers, connected together through suitable means.

In one example, during an operative phase, the computing system 210 is connected to a search engine portal through a network, such as the internet, and a user provides an input video search query to a video search engine through a web browser stored on the computing system 210. The proposed solution may be implemented on the computing system 210 or another computing device such as a server computer used to host a search engine portal.

It will be appreciated that the embodiments within the scope of the present solution may be implemented in the form of a computer program product including computer-executable instructions, such as program code, which may be run on any suitable computing environment in conjunction with a suitable operating system, such as Microsoft Windows, Linux or UNIX operating system. Embodiments within the scope of the present solution may also include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer.

It should be noted that the above-described embodiment of the present solution is for the purpose of illustration only. Although the solution has been described in conjunction with a specific embodiment thereof, numerous modifications are possible without materially departing from the teachings and advantages of the subject matter described herein. Other substitutions, modifications and changes may be made without departing from the spirit of the present solution.

We claim:

1. A computer-implemented method of performing a video search, comprising:
analyzing a search query, to identify a first set of query terms;
using the first set of query terms to query a knowledge repository, wherein the knowledge repository is a collection of electronic documents;
identifying an electronic document corresponding to the first set of query terms;
parsing the electronic document to obtain a second set of query terms;
ranking query terms obtained in the second set of query terms, by assigning a weight to the query terms; and
providing top N ranked query terms to a video search engine.

2. The method of claim 1, wherein analyzing a text string search query, to identify a first set of query terms, includes identifying noun phrases and focus words in the text string search query, wherein the noun phrases include nouns and proper nouns, and the focus words include nouns, proper nouns, non-trivial verbs, adjectives and numerals.

3. The method of claim 1, wherein parsing the electronic document to obtain a second set of query terms includes:
obtaining section headings present in the electronic document;
obtaining sub-section headings present in the electronic document;
obtaining hyperlinks present in the electronic document; and
obtaining noun phrases present in the electronic document, wherein the noun phrases are those which are not present in the section headings, the sub-section headings, and the hyperlinks of the electronic document.

4. The method of claim 3, further comprising combining the section headings, the sub-section headings, the hyperlinks, and said noun phrases to obtain the second set of query terms.

5. The method of claim 3, further comprising removing a duplicate entry.

6. The method of claim 1, wherein assigning a weight to the query terms, includes:
assigning relatively more weight to a query term present in the sub-section headings of the electronic document than to a query term present in the section headings of the electronic document;
assigning relatively more weight to a query term present in the hyperlinks of the electronic document than otherwise; and
recognizing those section and sub-section headings of the electronic document which share at least one common term with the second set of query terms, and upon recognition assigning relatively more weight to those query terms which are present in a text associated with aforesaid section and sub-section headings of the electronic document;

7. The method of claim 1, wherein identifying an electronic document corresponding to the first set of query terms includes identifying an electronic document whose title corresponds to the first set of query terms.

8. A system for performing a video search, comprising:
a user interface to obtain a video search query; and
a processor programmed to:
identify a first set of query terms from the video search query;
use the first set of query terms to query a knowledge repository, wherein the knowledge repository is a collection of electronic documents;
identify an electronic document corresponding to the first set of query terms;
parse the electronic document to obtain a second set of query terms;
rank query terms obtained in the second set of query terms, by assigning a weight to the query terms; and
provide top N ranked query terms to a video search engine.

9. The system of claim 8, wherein to identify a first set of query terms includes identifying noun phrases and focus words in the text string search query, wherein the noun phrases include nouns and proper nouns, and the focus words include nouns, proper nouns, non-trivial verbs, adjectives and numerals.

10. The system of claim 8, wherein to parse the electronic document to obtain a second set of query terms includes:
obtaining section headings present in the electronic document;
obtaining sub-section headings present in the electronic document;
obtaining hyperlinks present in the electronic document; and
obtaining noun phrases present in the electronic document, wherein the noun phrases are those which are not present in the section headings, the sub-section headings, and the hyperlinks of the electronic document.

11. The system of claim 8, wherein to assign a weight to the query terms, includes:
assigning relatively more weight to a query term present in the sub-section headings of the electronic document than to a query term present in the section headings of the electronic document;
assigning relatively more weight to a query term present in the hyperlinks of the electronic document than otherwise; and
recognizing those section and sub-section headings of the electronic document which share at least one common term with the first set of query terms, and upon recognition assigning relatively more weight to those query terms which are present in a text associated with aforesaid section and sub-section headings of the electronic document;

12. The system of claim 8, further comprising a display screen to display video search results provided by the video search engine.

13. The system of claim 8, wherein the knowledge repository is an external or an internal repository.

14. The method of claim 8, wherein the search query is a text input or a speech input.

15. A computer program product for performing a video search, the computer program product comprising:
a computer readable storage medium having computer usable program code embodied therewith, the computer usable program code comprising:
computer usable program code that analyzes a search query, to identify a first set of query terms;
computer usable program code that uses the first set of query terms to query a knowledge repository, wherein the knowledge repository is a collection of electronic documents;
computer usable program code that identifies an electronic document corresponding to the first set of query terms;
computer usable program code that parses the electronic document to obtain a second set of query terms;
computer usable program code that ranks query terms obtained in the second set of query terms, by assigning a weight to the query terms; and
computer usable program code that provides top N ranked query terms to a video search engine.
